(19) United States
(12) Patent Application Publication
(10) Pub. No.: US 2022/0029894 A1
(43) Pub. Date: Jan. 27, 2022

(54) REMOTE CONTROLLED INFORMATION DISPLAY SYSTEMS

(71) Applicant: Twentyseven Enterprises, Inc, Holualoa, HI (US)

(72) Inventors: Darren David, Holualoa, HI (US); Josh Wagoner, Fox Island, WA (US)

(73) Assignee: Twentyseven Enterprises, Inc, Holualoa, HI (US)

(21) Appl. No.: 17/497,659

(22) Filed: Oct. 8, 2021

Related U.S. Application Data
(63) Continuation of application No. 17/075,476, filed on Oct. 20, 2020.
(60) Provisional application No. 63/037,999, filed on Jun. 11, 2020.

(51) Int. Cl. H04L 12/24; G06K 7/10; G06K 7/14; H04L 5/14; H04L 29/08; H04L 29/12; H04L 29/06; G06F 3/0488

(52) U.S. Cl. CPC H04L 41/22; G06K 7/10297; G06K 7/1417; H04L 5/14; H04L 67/02; G06F 3/04883; H04L 67/146; G06K 7/1413; H04L 61/2007; H04L 67/2842; H04L 67/42; H04L 67/141

(57) ABSTRACT

Provided is a process that controls an information display system (IDS) using a mobile computing device associated with a user by establishing a connection between the mobile computing device and the IDS, and transmits input events, such as touch events, on the mobile computing device to a server associated with the IDS, which further transmits the touch events to the IDS for performing one or more operations in the IDS responsive to the touch events.

### CROSS-REFERENCE TO RELATED APPLICATIONS

The present application claims priority to U.S. Provisional Patent Application No. 63/037,999 filed on Jun. 11, 2020 entitled “REMOTE CONTROLLED INFORMATION DISPLAY SYSTEMS,” the contents of which are herein incorporated by reference in their entirety.

### BACKGROUND

### 1. Field

The present disclosure relates generally to distributed computer systems and, more specifically, to controlling an information display system, such as a public touchscreen kiosk, using a private mobile computing device.

### 2. Description of the Related Art

Public information displays are widespread and useful in many instances, such as at street corners, in bus stations, at mall directories, museums, etc. Some displays may be interactive, such as kiosks having user interfaces accessible by a user seeking a particular type of information. These kiosks often require users to touch the same input devices, like touchscreens, buttons, keyboards, etc., as previous users.

### SUMMARY

The following is a non-exhaustive listing of some aspects of the present techniques. These and other aspects are described in the following disclosure.

Some aspects include a process for controlling an information display system (IDS) using a mobile computing device by establishing a connection between the mobile computing device and the IDS, and transmitting input events, such as touch events, on the mobile computing device to a server associated with the IDS, which further transmits the touch events to the IDS for performing one or more operations in the IDS responsive to the touch events.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a block diagram of an environment in which the disclosed embodiments may be implemented, in accordance with one or more embodiments.

FIG. 2A is a block diagram of a system for controlling a host computer system from a mobile computing device, in accordance with one or more embodiments.

FIG. 2B is a sequence diagram of a process for controlling a host computer system using a mobile computing device, in accordance with one or more embodiments.

FIG. 3 is a block diagram for geolocation-based verification of a connection request, in accordance with one or more embodiments.

FIG. 4 is a flowchart of a process for controlling a host computer system from a mobile computing device, in accordance with one or more embodiments.

FIG. 5 illustrates an example of a computing system in which the disclosed embodiments may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of information display systems. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Many existing information display system (IDSs), such as touchscreen kiosks, have user interfaces accessible by a user seeking a particular type of information. These IDSs often require users to share the same input devices, like touchscreens, etc., as previous users. Users, however, often desire to avoid touching surfaces that have been touched by others, particularly with the advent of COVID-19.

Some existing IDSs provide contactless interaction experiences to users via gesture-based control, voice-based control, or other similar interactions. However, the accuracy of such controls is not consistent leaving the users frustrated at time, and such IDSs also involve a learning curve for the users in learning the contactless interactions. Some existing IDSs may allow users to connect a mobile computing device, such as a smartphone, to an IDS to control the IDS but they do not provide adequate security to protect user's information that may be transmitted between the IDS and mobile computing device or that may be stored by the IDS. Some existing IDSs may allow users to connect a mobile computing device to an IDS via Bluetooth or near field communication (NFC) or other such protocol. However, such systems require specific hardware to enable such wireless connections and retrofitting of such hardware to existing IDSs to provide contactless interaction may be cost prohibitive or not possible. In some cases, it may be undesirable to install special purpose native applications on mobile computing devices to control an IDS, as doing so may add friction to the user experience that deters an excessive number of potential users. None of the preceding should be read to suggest that such approaches are disclaimed, as they may be combined with various techniques discussed below.

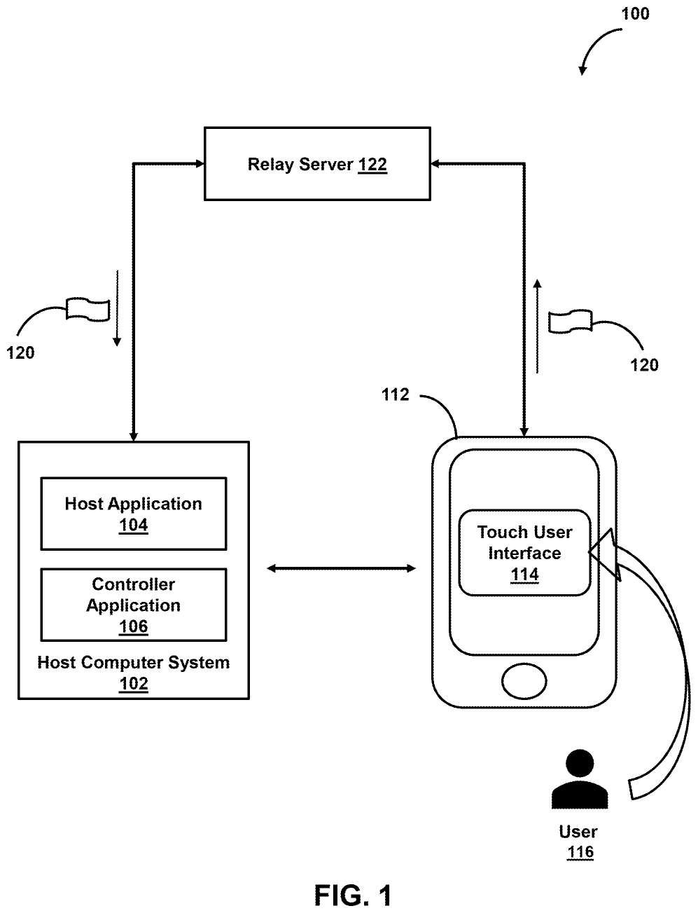

FIG. 1 is a block diagram of an environment in which the disclosed embodiments may be implemented, in accordance with one or more embodiments. The environment 100 includes a host computer system 102, e.g., an IDS, such as a touchscreen kiosk, hosting a host application 104, which has graphical user interfaces (GUIs) accessible by a user 116 seeking a particular type of information. For example, the host computer system 102 may be a touchscreen kiosk in a shopping mall and the host application 104 may provide a GUI for viewing a map of the shopping mall, access information regarding the stores in the shopping mall, etc.

In some embodiments, the host computer system 102 executes a controller application 106 that cooperates with a remote server, e.g., a relay server 122, to configure a mobile computing device 112 (e.g., a smartphone) associated with a user 116 as an input interface (e.g., a touchpad) for the host computer system 102 to allow the user 116 to control the host application 104 by inputting touch events 120 in the mobile computing device 112. In some cases, this is done without installing a special purpose native application on the mobile computing device 112, e.g., via a pre-existing browser application.

In some embodiments, the host computer system 102 includes a processor (e.g., a micro-controller or CPU in ASIC or FPGA form) executing logic (e.g., hard-wired, or programmed as software or firmware stored in volatile or non-volatile memory of the host computer system 102). The host computer system 102 may also be in communication with a server computing device (“server”). And that server may provide similar services to a population of host computer system 102s controlled by a plurality of different entities, e.g., a dozen museums may have accounts by which multiple host computer systems 102 at each of their facilities are controlled.

In some embodiments, the logic may execute a control routine that takes input from the mobile computing device 112 (e.g., a request from the user to establish a connection between the mobile computing device 112 and the host computer system 102, touch events 120 input on the mobile computing device, etc.), process the input (e.g., establish the connection between the mobile computing device and the host computer system 102, translate the touch events 120 received from the mobile computing device into touch events associated with the host computer system 102, etc.), and generate an output based on the processing of the input (e.g., perform host computer system 102 related operations such as executing a user query identified by the touch events and presenting the output of the query on the host computer system 102 or the mobile computing device).

While the touchscreen device, such as a kiosk, is one example of the host computer system 102, the host computer system 102 can include any other computing device having an input device and an output device and capable of connecting to a communication network (e.g., a wired network or a wireless network, like WiFi, cellular network, Bluetooth, etc.). For example, the host computer system 102 may include an automated teller machine (ATM), a gas station kiosk, credit card reader, digital signage, Jumbotrons, computer systems for displaying digital ads on buildings, etc. In another example, the host computer system 102 can be a system which has tiled displays where multiple displays are arranged in a matrix form to show the GUI of a single host application 104. In some embodiments, the host computer system 102 can include an input/output device such as a touchscreen device, which can serve as both input and output device. In some embodiments, the host computer system 102 can include an additional input device, such as a keyboard. Further, in some embodiments, the input device and the output device of the host computer system 102 can be separate, such as a display monitor and a keyboard. The host computer system 102 may have any of a number of operating systems, e.g., Microsoft Windows, Linux, macOS, etc.

The mobile computing device 112 can include any portable computing device, such as a laptop, a tablet PC, a smartphone, a wearable device, etc. The mobile computing device 112 displays a touch user interface (UI) 114, which is a GUI that allows the user 116 to input touch events 120 in the mobile computing device 112 for controlling the host application 104 at the host computer system 102. The touch events 120 can include multiple forms of user input. For example, a touch event can include a gesture, such as a movement, tap, tap-and-hold, short-press, long-press, drag, scroll, swipe, or a multi-touch gesture such as pinch and zoom, two-finger movement, three-finger movement, etc. The touch UI 114 may have various controls. For example, the touch UI 114 may have application-specific inputs, such as a “select” button, a “back” button, arrow keys, etc. In another example, the touch UI 114 may include “joystick” like controls to simulate up, down, left, right, back, select or other actions. In another example, the touch UI 114 may also include some keyboard controls. In another example, the touch UI 114 may have a “screen capture” button, which may capture an image of a portion of the screen of the host computer system 102 and receive the captured image on the mobile computing device 112. The captured image may be a zoomed-in view a specified portion of the screen adjacent to a cursor displayed on the screen. In another example, the touch UI 114 may determine a selection of an on-screen keyboard on the screen of the host computer system 102 and in response to the determination of the selection, the touch UI 114 may cause the mobile computing device 112 to display a native keyboard, e.g., keyboard associated with an operating system of the mobile computing device 112 for the user 116 to input text. In some embodiments, the touch UI 114 may allow the user 116 to customize the touch UI 114, e.g., select a display language.

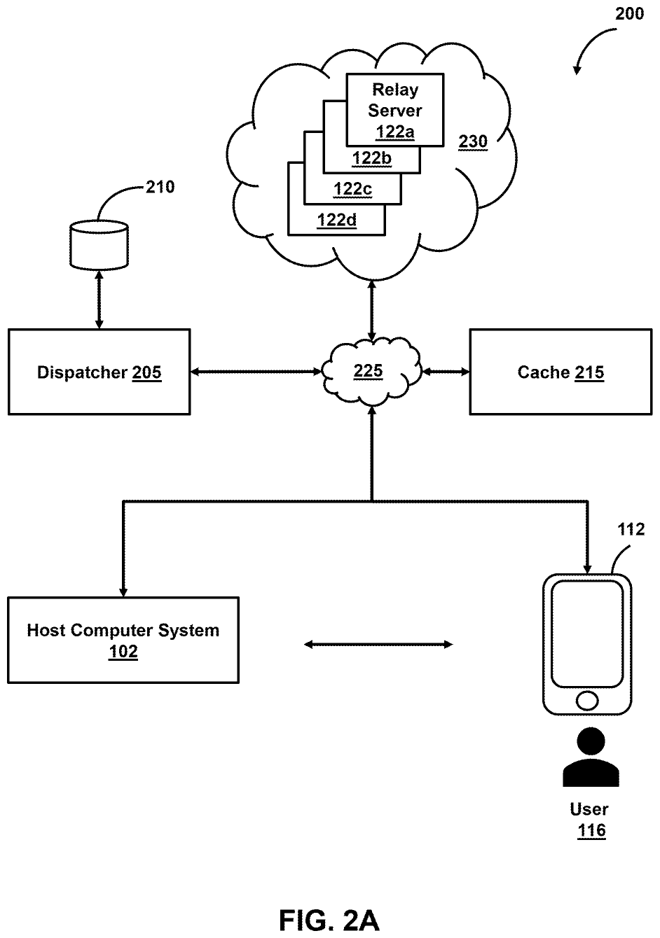

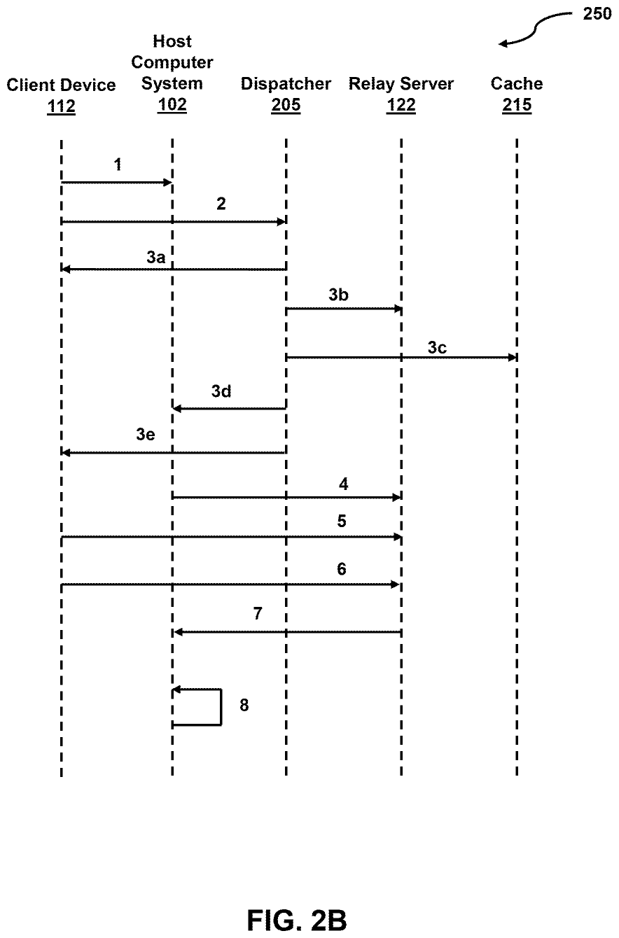

In some embodiments, the mobile computing device 112 may connect to the host computer system 102 in an ad hoc way. For example, the user 116 can engage a camera of the mobile computing device 112 to scan a quick response (QR) code displayed on the host computer system 102 to connect with the host computer system 102. Upon scanning the QR code, the mobile computing device 112 can be connected to a relay server 122 associated with the host computer system 102, and the touch UI 114 be loaded in the mobile computing device 112. The user 116 may input touch events 120 on the mobile computing device 112 via the touch UI 114. The touch events 120 are transmitted to the host computer system 102 via the relay server 122. The controller application 106 can translate those touch events 120 into a format understandable by the host computer system 102, e.g., native touch events. The host computer system 102 responds to these touch events 120 as if they were input events which were input directly on the host computer system 102. For example, the host computer system 102 performs operations corresponding to the touch events 120, e.g., executing various corresponding event handlers, like receiving a user query represented by the touch events and executing the user query to display results of the user query. In some embodiments, touch events 120 input on the mobile computing device 112 may be shown on the host computer system 102 via a cursor displayed on the host computer system 102 that responds to the touch events 120. For example, a movement or swipe touch event on the mobile computing device 112 is shown via a movement of the cursor on the host computer system 102. Additional details with respect to controlling the host computer system 102 from the mobile computing device 112 are described in the following paragraphs and at least with reference to FIGS. 2A and 2B.

FIG. 2A is a block diagram of a system 200 for controlling a host computer system from a mobile computing device, in accordance with one or more embodiments. In some embodiments, the system 200 may be implemented in the environment 100 of FIG. 1. While a relay server facilitates transmission of touch events from the mobile computing device 112 to the host computer system 102, a number of relay servers 122a-n may be deployed to facilitate transmission of the touch events between multiple mobile computing devices and multiple host computer systems. A dispatcher 205 may maintain a list of all relay servers 122a-n and may query all the relay servers 122a-n when the session is initiated to identify one of the relay servers 122a-n that a mobile computing device can connect with to control a host computer system. In some embodiments, the dispatcher 205 may identify a relay server that satisfies a specified condition, e.g., a relay server with a lowest latency, latency below a first threshold, highest capacity, or capacity above a second threshold, as the relay server that the mobile computing device 112 can connect with to control the host computer system 102. After identifying the relay server 122, the dispatcher 205 may return an identifier of the identified relay server 122 (e.g., hostname, IP address) to both the mobile computing device 112 and the host computer system 102 each of which may then contact the identified relay server 122 to start a new session.

FIG. 2B is a sequence diagram of a process 250 for controlling a host computer system using a mobile computing device, in accordance with one or more embodiments. The processing operations presented below are intended to be illustrative and non-limiting. In some embodiments, for example, the process 250 may be accomplished with one or more additional operations not described, and/or without one or more of the operations discussed. Additionally, the order in which the processing operations of the process are illustrated (and described below) is not intended to be limiting.

In some embodiments, the process 250 may be implemented using the system 200 of FIG. 2A. In an operation 1, the mobile computing device 112 may perform one or more operations to initiate a session or establish a connection with the host computer system 102. For example, the user 116 may engage a camera of the mobile computing device 112 to scan a QR code displayed on the host computer system 102 to connect with the host computer system 102. In some embodiments, a service executing on the host computer system 102, such as the controller application 106, generates a QR code for display on the host computer system 102. The QR code may encode a uniform resource locator (URL) of the dispatcher 205. The QR code may also encode a unique identifier (ID) of the host computer system 102 (e.g., among a population of such host computer systems), which may be correlated with an Internet Protocol (IP) address of the host computer system 102. The ID of the host computer system 102 may also be correlated with various other information, e.g., network address translation (NAT) information, connection information to the relay server 122 such as Web Socket ID or webRTC information, etc.). In some cases, the correlated information may facilitate NAT traversal to a private IP address of the host computer system 102 from a public IP address of the relay server 122. The QR code may also encode a session ID, e.g., universally-unique ID (UUID), that is unique to a session, which is representative of a given connection between the host computer system 102 and a specific mobile computing device, e.g., the mobile computing device 112. The session ID can be different for sessions (e.g., different session IDs for different mobile computing devices or the same device at different times). In some embodiments, the controller application 106 generates a unique session ID for each session (e.g., each session ID may be used only once).

In an operation 2, upon scanning the QR code, the mobile computing device 112 is caused to request browser-executable content at the URL that resolves to an IP address of the dispatcher 205.

In an operation 3a, the dispatcher 205 may respond to the request by loading a webpage having the touch UI 114 in a browser of the mobile computing device 112. The touch UI 114 has a touchpad for controlling the host computer system 102. In some embodiments, the browser-executable code of the touch UI 114 may be stored in a storage system 210. The browser-executable code of the ouch UI 114 may be stored in various formats, e.g., as Blob storage, that is designed for storage of arbitrarily large amounts of unstructured data, for storing files for distributed access, and for serving data to users over various transportation protocols, such as hypertext transfer protocol (HTTP), hypertext transfer protocol secure (HTTPS), Web Socket.

The touch UI 114 may be generated in the mobile computing device 112 in many ways. For example, the touch UI 114 may be generated in a web browser of the mobile computing device 112, e.g., with in-browser-executed JavaScript or WebAssembly sent from the dispatcher 205 that includes event handlers that receive UI events and send them to the relay server 122, in some cases. In another example, the touch UI 114 is generated in a mobile app associated with the host computer system 102 which the user may install on the mobile computing device from an app store associated with the mobile computing device. In yet another example, the touch UI 114 may be displayed using a portion of a mobile app associated with the host computer system 102 which is automatically downloaded to the mobile computing device 112 on demand (e.g., when the user scans the QR code) to render the touch UI 114 and is automatically removed upon the session being terminated. The touch UI 114 may display the content from the host computer system 102. For example, the touch UI 114 may mirror the content displayed on the host computer system 102, display a portion of the content, display a set of GUI elements (e.g., buttons, keyboard, etc.), or a touchpad on which the user 116 can perform touchpad related gestures, such as scrolling, tapping, swiping etc.

In an operation 3b, the dispatcher identifies a relay server 122 to facilitate the session between the mobile computing device 112 and the host computer system 102. In some embodiments, relay servers 122a-n are a set of servers hosted in a cloud-based platform 230. The relay servers 122a-n may, among other functions, relay data between two entities, e.g., from the mobile computing device 112 to host computer system 102. The available capacity or a latency of a relay server may depend on various factors. For example, they may depend on available computing resource, an available network bandwidth, a current load, a geographical location of the relay server, etc. The dispatcher 205 may query the relay servers 122a-n to identify a relay server 122 that satisfies a specified condition, e.g., a relay server with the lowest latency, latency below a first threshold, highest capacity, or capacity above a second threshold, to host a new session.

In an operation 3c, upon identifying a relay server 122, the dispatcher 205 updates a session cache 215 with an entry associating the identified relay server 122 with the session ID. For example, the dispatcher may generate an entry “<session ID>:<hostname>” where the hostname is an identifier of the identified relay server 122. In some embodiments, the identifier may include an IP address of the identified relay server 122. The system 200 may track which sessions are live, e.g., using the session cache 215, and may block UI events for sessions that have been terminated (e.g., timed out, were replaced by a newer request for a session, etc.). In some embodiments, the controller application may generate a new QR code for each session. For example, after a current session with a current user 116 is terminated, the controller application 106 may generate a new QR code (encoding a new session ID) that is different, at least in part, from the QR code used by the mobile computing device 112 of the current user 116, for a next user to connect their mobile computing device to the host computer system 102. After a current session is terminated, the dispatcher 205 or the relay server 122 may update the session cache 215 to indicate that the current session is terminated.

In some embodiments, the session cache 215 may be used to reconnect the mobile computing device 112 or the host computer system 102 to the same relay server 122 in an event the mobile computing device 112 or the host computer system 102 disconnect inadvertently (e.g., when the user 116 switches his mobile computing device 112 from WiFi to cellular network during a session). For example, if the mobile computing device 112 is connected to a relay server 122a during a session with session ID “1” and the mobile computing device disconnects from the relay server 122a for some reason, the dispatcher 205 obtains information of the relay server 122a the mobile computing device 112 was connected to, e.g., relay server 122a associated with the session ID “1” in the session cache 215, and returns the information to the mobile computing device 112, which can then reconnect with the relay server 122a.

In some embodiments, the session cache 215 is implemented as an in-memory data structure. The session cache 215 may be implemented as a distributed, in-memory key-value database and may support different kinds of abstract data structures, such as strings, lists, maps, sets, sorted sets, HyperLogLogs, bitmaps, streams, spatial indexes, etc.

In an operation 3d, the dispatcher 205 may return an identifier of the relay server 122 (e.g., hostname, IP address, etc.) to the host computer system 102.

In an operation 3e, the dispatcher 205 may return the identifier of the relay server 122 to the mobile computing device 112.

In an operation 4, upon receiving the identifier of the relay server 122, the host computer system 102 may establish a connection with the specified relay server 122. In some embodiments, the host computer system 102 and the relay server 122 may establish a connection using a secure communication protocol, such as WebSocket, HTTPS, etc. In some embodiments, any data transmitted between the host computer system 102 and the relay server 122 using the secure communication protocol may be encrypted.

In an operation 5, upon receiving the identifier of the relay server 122, the mobile computing device 112 may establish a connection with the specified relay server 122, e.g., using a secure communication protocol, such as WebSocket, HTTPS, etc. In some embodiments, any data transmitted between the mobile computing device 112 and the relay server 122 using the secure communication protocol may be encrypted.

After both the host computer system 102 and the mobile computing device 112 are connected to the relay server 122, the connection between the host computer system 102 and the mobile computing device 112 is considered to established and the session to be started.

In an operation 6, the touch events 120 captured in the touch UI 114 on the mobile computing device 112 may be transmitted to the relay server 122. In some embodiments, the touch events 120 may be converted to serialized data, e.g., JSON, by the touch UI 114 prior to transmission to the relay server 122.

In an operation 7, the relay server 122 transmits the touch events 120 received from the mobile computing device 112 to the host computer system 102. The touch events 120 are forwarded to the host computer system 102 in a format received from the mobile computing device 112, e.g., as serialized data.

In an operation 8, upon receiving the touch events 120, the controller application 106 may translate the received touch events 120 into a format understandable by the host computer system 102, e.g., native touch events, and the host computer system 102 may respond to these input events as if they were input directly on the host computer system 102. In some embodiments, the host computer system 102 may perform operations corresponding to the touch events 120, e.g., executing various corresponding event handlers, like receiving a user query represented by the touch events and executing the user query to display results of the user query. For example, if the host computer system 102 is a public kiosk installed in a shopping mall that displays the mall directory and the touch events 120 in the mobile computing device 112 correspond to a user selection of a particular store listed in the directory, the host computer system 102 may execute a query to output (e.g., display) a map of the mall identifying a location of the particular store. The map may be output on the host computer system 102 or on the mobile computing device 112 in the touch UI 114.

In some embodiments, the controller application 106 may translate the touch events 120 to native events using an application programming interface (API) of an operating system of the host computer system 102. For example, if the host computer system 102 is executing a Microsoft Windows operating system, the controller application 106 may use WIN32 API for translating and executing the touch events 120 at the host computer system 102. Some of the APIs include “user32.dll” functions such as “InitializeTouchInjection,” “InjectTouchInput,” “GetSystemMetrics,” “SendInput,” “GetWindowLong,” “SetWindowLong,” “SendMessage,” “SetWindowsHookEx,” “UnhookWindowsHookEx,” etc. Some of the APIs include “kernel32.dll” functions such as “OpenProcess,” “ReadProcessMemory,” “WriteProcessMemory,” “LoadLibrary,” “GetProcAddress,” “GetModuleHandle,” etc. Other such APIs may be used for translating the touch events 120 based on the operating system of the host computer system 102.

While the foregoing description describes establishing a connection between the mobile computing device 112 and the host computer system 102 using a QR code, the connection to the host computer system 102 can be established in ways other than the QR code. For example, the user 116 can scan a bar code, or other optical code, displayed on the host computer system 102 using the mobile computing device 112. In another example, the host computer system 102 can display instructions asking the user 116 to navigate to a website at a specified URL in the mobile computing device 112 and to enter an ID of the host computer system 102 (which may be displayed on the host computer system 102) in the website to establish a connection with the host computer system 102. In another example, the mobile computing device 112 can be connected to the host computer system 102 via Bluetooth, near field communication (NFC) or other such protocols. For example, an NFC tag associated with the host computer system 102 may encode a URL of the dispatcher 205 (e.g., like the QR code) and when the mobile computing device 112 is brought in proximity to, or tapped on, the NFC tag, the connection between the mobile computing device 112 and the host computer system 102 may be established. The connection between the mobile computing device 112 and the host computer system 102 is established via communication network 225 (e.g., a wired interface, or a wireless network interface, like a cellular network interface, a WiFi interface, Bluetooth, NFC, etc.).

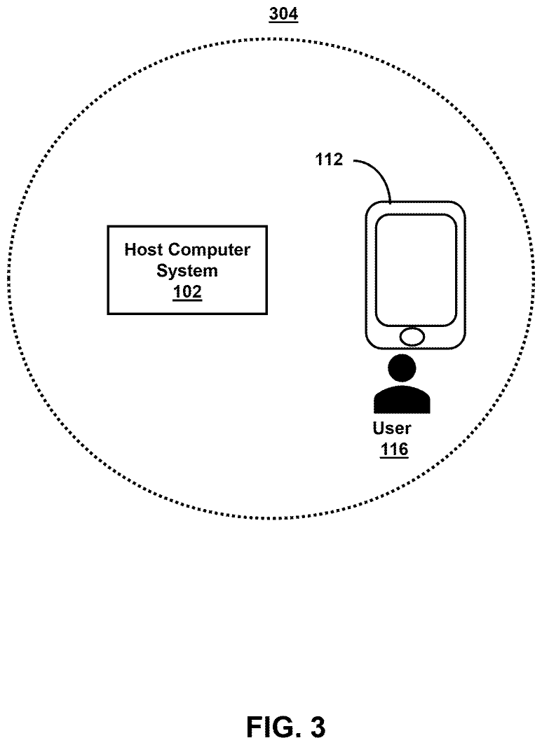

In some embodiments, the system 200 may allow the mobile computing device 112 to connect to the host computer system 102 if a specified condition is satisfied. FIG. 3 is a block diagram for geolocation-based verification of a connection request, in accordance with one or more embodiments. In some embodiments, the system 200 may allow the mobile computing device 112 to connect to the host computer system 102 if the mobile computing device 112 is within a specified proximity 304 to the host computer system 102. For example, the specified proximity 304 can be the same geolocation (e.g., physical address) as the host computer system 102. In another example, the specified proximity 304 can be the same floor of a building in which the host computer system 102 is located. In another example, the specified proximity 304 can be a few meters from the host computer system 102. The system 200 may determine a geolocation of the mobile computing device 112 in various ways. For example, the system 200 may obtain the geolocation of the mobile computing device 112 using one or more services executing in the mobile computing device 112, or determine based on an IP address of the mobile computing device 112, a cellular network tower to which the mobile computing device 112 is connected, an access point to which the mobile computing device is connected, etc. In some embodiments, the system 200 may determine whether the mobile computing device 112 is in the specified proximity 304 of the host computer system 102 based on a response received from the mobile computing device 112 for a beacon transmitted by the host computer system 102. In some embodiments, the beacon can be transmitted by the host computer system 102 using Bluetooth, ultra-wide band (UWB), or other wireless technology. If the mobile computing device 112 is within the specified proximity 304 (e.g., <10 m, <100 m, or other values), then the mobile computing device 112 responds to the beacon, indicating that the mobile computing device 112 is within the specified proximity 304 of the host computer system 102. After the system 200 confirms that the mobile computing device 112 is within the specified proximity 304 of the host computer system 102, the mobile computing device 112 may establish a connection with the host computer system 102 as described at least with reference to FIGS. 2A and 2B.

In some embodiments, more than one mobile computing device may be connected to the host computer system 102 simultaneously (“multi-user mode”). For example, after a first user successfully establishes a connection between a first mobile computing device and the host computer system 102 (e.g., using a first QR code displayed on the host computer system 102), the host computer system 102 may be display a second QR code, which can be used to establish a connection between a second mobile computing device of a second user and the host computer system 102. The second QR code may encode a new session ID, e.g., a session ID different from the session ID encoded in the first QR code. In the multi-user mode, the host computer system 102 may display a GUI associated with the host application 104 or the results of the user query in various ways. For example, the host computer system 102 may display multiple cursors, one for each user, in a display of the host computer system 102 and may split the display area into multiple portions, one portion for each user, and display the GUI of the host application 104 in each of the portions. The user interactions of the first user may be displayed in a first portion of the display of the host computer system 102 and the user interactions of the second user may be displayed in a second portion of the display. In some embodiments, the display area may not be split into multiple portions and each of the users may have access to the entire display area in the multi-user mode. In some embodiments, each cursor may have a different color that maps to a color of the touch UI (e.g., a colored border of the touch UI) displayed on the mobile computing device of the corresponding user. In another example, the GUI of the host application 104 or the results or the user query may be displayed on the mobile computing device of the corresponding user but not on a display screen of the host computer system 102.

In some embodiments, a new QR code is displayed on a screen of the host computer system 102 as soon as a first user scans the QR code displayed on the screen. In some embodiments, in a single-user mode (e.g., a mode in which multiple users are note supported), when a second user scans the new QR code, the session associated with the first user may be terminated.

In some embodiments, a QR code may be used only once. The system 200 may validate that a session ID is valid only on a single mobile computing device-host computer system pair at a time, e.g., to ensure that no other device can spoof and listen in on data transmitted between the mobile computing device-host computer system pair, thereby avoiding data theft (e.g., IP sniffing, browser fingerprinting, etc.).

In some embodiments, the host computer system 102 may display a status of the connection with the mobile computing device 112. For example, the host computer system 102 may display whether the host computer system 102 is connected to the mobile computing device 112, whether the session is in progress or terminated, a duration of the session, a remaining time of the session, or other information. The session between the mobile computing device 112 and the host computer system 102 may be terminated in various ways. For example, the session may be configured to expire after a configurable period of time. In another example, the session may be terminated if no input events are received from the mobile computing device 112 within a configurable timeout duration. In another example, a current session of a first user may be terminated (e.g., in a single-user mode) when a second user scans the new QR code displayed on the host computer system 102. In another example, the current session may be terminated if the screen of the host computer system 102 is touched or any input event is provided via the screen or other input device of the host computer system 102. In another example, the current session may be terminated if the user 116 closes, or exits from, the browser on the mobile computing device 112. In another example, the current session may be terminated manually by the user.

In some embodiments, the system 200 also supports controlling the host computer system 102 using TUIO input, which is an open framework that defines a common protocol and API for tangible multitouch surfaces. The TUIO protocol allows the transmission of an abstract description of interactive surfaces, including touch events and tangible object states. This protocol encodes control data from a tracker application (e.g. based on computer vision) and sends it to any client application that is capable of decoding the protocol.

In some embodiments, the relay servers 122a-n and the dispatcher 205 may send telemetry data to a service in the cloud-based platform 230, which may be used to generate various analytical reports (e.g., real-time and historical performance data).

In some embodiments, the controller application 106 allows a host user, e.g., a user associated with the host computer system 102, to perform various customizations. For example, the host user may configure a location of the QR code on the screen of the host computer system 102, a size of the QR code, the display language for the QR code label, the touch UI 114, an image of the cursor overlay, size of the cursor image, etc. In another example, the host user may set whether or not the host computer system 102 should respond to one or more gestures or a multi-touch gesture. In another example, the host user may configure the speed (e.g., movement sensitivity) of the cursor on the host computer system 102. In another example, the host user may configure the speed (e.g., movement sensitivity) of the virtual scale (e.g., pinch-zoom). In another example, the host user may configure cursor boundary (e.g., a boundary on the host computer system 102 within which a cursor may move). In some embodiments, setting the cursor boundary may be necessary in multiple display systems where the cursor needs to be constrained to a single display.

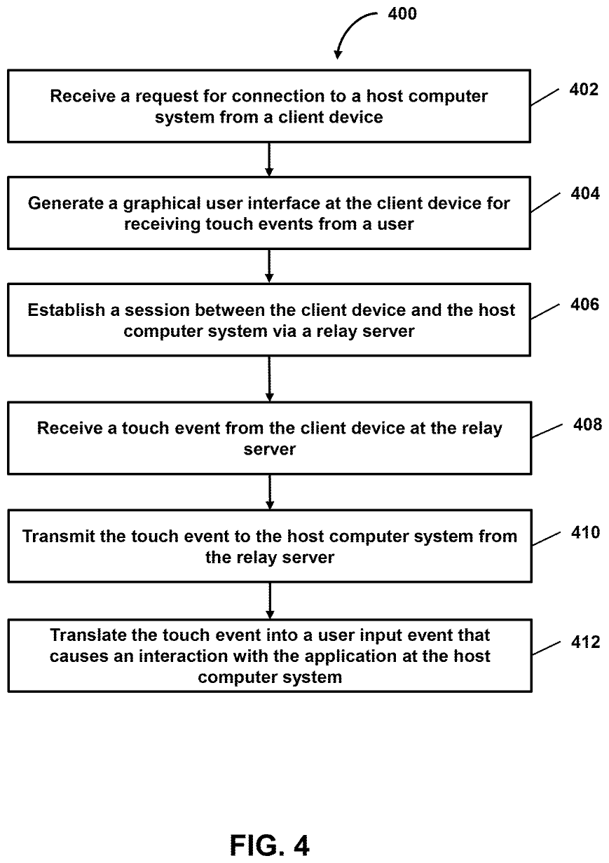

FIG. 4 is a flowchart of a process 400 for controlling a host computer system from a mobile computing device, in accordance with one or more embodiments. In some embodiments, the process 400 may be implemented using the system 200 of FIG. 2A. The processing operations of each method presented below are intended to be illustrative and non-limiting. In some embodiments, for example, the methods may be accomplished with one or more additional operations not described, and/or without one or more of the operations discussed. Additionally, the order in which the processing operations of the methods are illustrated (and described below) is not intended to be limiting.

In some embodiments, the methods may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on an electronic storage medium. The processing devices may include one or more devices configured through hardware, firmware, and/or software to be specifically designed for execution of one or more of the operations of the methods.

In an operation 402, a request for connection to, or for establishing a session with, a host computer system 102 is received from a mobile computing device 112. In some embodiments, the request is received at a dispatcher 205. The request for connection may be initiated from the mobile computing device 112 in various ways as described above. For example, the request may be initiated by the mobile computing device by scanning a QR code displayed on the host computer system 102. In another example, the request may be initiated by the mobile computing device 112 by navigating to a website at a specified URL displayed on the host computer system 102.

In operation 404, a GUI having a touchpad to control the host computer system 102 is generated in the mobile computing device 112 in response to receiving the request for connection. For example, the touch UI 114 is loaded in a browser of the mobile computing device 112. In some embodiments, the browser-executable content corresponding to the touch UI 114 may be stored in the storage system 210, which is downloaded to the mobile computing device 112 in response to the dispatcher 205 receiving the request for connection.

In operation 406, a connection between the host computer system 102 and the mobile computing device 112 is established. In some embodiments, establishing the connection between the host computer system 102 and the mobile computing device 112 includes identifying, by the dispatcher 205, in response to receiving the request for connection, a relay server 122 that satisfies a specified condition for hosting a session, or facilitating data transmission, between the host computer system 102 and the mobile computing device 112, and having both the host computer system 102 and the mobile computing device 112 connect to the identified relay server 122.

In operation 408, touch events 120 input on the mobile computing device 112 are received at the relay server 122. For example, the touch UI 114 transmits the touch events 120 to the relay server 122. In some embodiments, the touch events 120 are converted to serialized data, e.g., JSON format, prior to transmission.

In operation 410, the touch events 120 received at the relay server 122 are relayed or transmitted to the host computer system 102. In some embodiments, the touch events 120 are transmitted to the host computer system 102 in a format in which they were received at the relay server 122 (e.g., serialized data).

In operation 412, the touch events 120 received at the host computer system 102 are translated into a format understandable by the host computer system 102, e.g., native touch events, causing the host computer system 102 to respond to these input events as if they were input directly on the host computer system 102. For example, if the host computer system 102 is a public kiosk installed in a shopping mall that displays the mall directory and the touch events 120 in the mobile computing device 112 correspond to a user selection of a particular store listed in the directory, the host computer system 102 may execute a query to output (e.g., display) a map of the mall identifying a location of the particular store. In some embodiments, the host computer system 102 may translate the touch events 120 to native events using an API of an operating system of the host computer system 102. For example, if the host computer system 102 is executing a Microsoft Windows operating system, the touch events 120 may be translated and executed at the host computer system 102 using the WIN32 API.

In some embodiments, the above method allows the user to control the host computer system 102 from the mobile computing device 112 in an ad hoc way as the user does not have to install any additional software, e.g., a mobile app, or does not have to create a user profile with the host computer system 102, which makes it convenient to the user. Further, the above method allows the user to control the host computer system 102 from the mobile computing device 112 anonymously as the user does not have to create a user profile or input any user identifiable information (e.g., name, age, contact information, etc.) in the host computer system 102 to access the host computer system 102 from the mobile computing device 112, thereby keeping the session anonymous.

The present techniques may be implemented with a variety of different physical and logical architectures. Some embodiments may collectively, through cooperation of a plurality of different computing devices, implement a process that includes the following operations.

Some embodiments include associating a mobile user device with an IDS to establish a session. As discussed above, in some embodiments this may include scanning a QR code displayed on a display screen of the IDS. In some embodiments, the association may be established by wirelessly receiving, with the mobile user device, a set of values that, in some cases, uniquely identify a session to distinguish that session from a previous session and uniquely identify the IDS among a set of IDS is supported by remote server system with which sessions are established. In some embodiments, when the association is established, the mobile user device may be co-located with the IDS, for instance, in the same room, or within wireless transmission range, like within less than 20 meters or less than 50 meters. In some embodiments, the mobile user device may be close enough that the user can view and read text on a display screen of the IDS when the association is established.

In some embodiments, the association between the mobile user device and the IDS is established by the mobile user device wirelessly receiving a set of values. In some embodiments, the wireless transmission is optical transmission, for instance, with a camera of the mobile user device capturing an image displayed by the IDS. In some embodiments, the wireless transmission is performed through near field communication or via exchanges on a local area network, like a Wi-Fi network, for instance via Wi-Fi direct exchanges, or via Bluetooth transmissions.

In some embodiments, the set of values received by the mobile user device are received through a plurality of different channels. For example, an identifier of the service provided by a remote server system for establishing sessions may be wirelessly received from an IDS (or a display associated with the IDS, like a printout of a QR code positioned adjacent the IDS). And the mobile user device may then determine a geolocation of the mobile user device via a location service of an operating system of the mobile use device, for instance, based upon global positioning system satellite signals, cellular tower triangulation, SSID's he encoded in Wi-Fi signals, low energy Bluetooth beacon identifiers, and the like. Collectively, the two values indicating the identifier of the service and the geolocation may uniquely identify the IDS among a plurality of IDS is served by the remote server system (and in some cases, both values may be encoded in a single string, like as a hash of the two, or as a concatenated string).

In some embodiments, a unique session identifier is not received in the set of values, which is not to suggest that any other feature described herein is not also optional, and a unique session identifier that distinguishes a new session from previous sessions with the IDS may be determined by, for example, incrementing a counter or decrementing a counter. The session identifier may be determined by the mobile user device, the remote server system, or the IDS. To make it more difficult to guess session identifiers (e.g., in an attempted intrusion) based upon a known current session identifier, for instance, to interfere with subsequent sessions, some embodiments may compute session identifiers with, for example, one-way functions that obfuscate a next identifier given a current identifier. In some embodiments, a linear shift register met may be incremented or decremented, or a count may be appended to a current date and time and input to a cryptographic hash function that produces a unique session identifier. In some embodiments, the session identifier may be determined on the mobile computing device, the IDS, or the remote server system by which sessions are established.

In some embodiments, the set of values wirelessly received by the mobile user computing device may include a uniform resource identifier, like a uniform resource locator received via scanning a QR code (or other code, like optical barcode, optical codes in a polar coordinate system with a generally circular shape, optical codes encoded in a flashing screen, optical codes encoded in modulating of overhead lighting or those encoded in in-store music or ultrasonic transmissions, or the like). Or in some cases the URL or other type of URI may be received via near field communication transmission, for instance by the IDS, effected by a process running on the IDS with which other aspects of the described techniques are implemented, like injecting touch events into another application providing a user interface on the IDS. In some embodiments, the URL may be encoded permanently in an NFC tag associated with the IDS. In some embodiments, the URL includes one or more query string parameters. In some embodiments, the URL may correspond in a domain name system to an IP address of the remote server system by which sessions are established, and the query string parameters appended thereto may uniquely identify the specific IDS or a tenant account of a tenant having a plurality of IDSs. In some embodiments, a query string parameter may also uniquely identify a new session (which may be a session that is yet to be established) with the IDS in a manner that distinguishes the new session from previous sessions, such as previous sessions in the same day or previous sessions overall time.

In some embodiments, a client application of the service by which a session is established with the IDS is already running on the mobile user device when the set of values are wirelessly received, for instance, a user may launch a corresponding preinstalled native application, which may present a user interface that invites the user to scan a QR code, for example by registering the native application to handle requests to the URL in the operating system, like with an intent filter in an Android manifest. In some embodiments, that client application may not yet be installed (or otherwise executing, for instance, as a web application executing in a web browser on the mobile user device), and some embodiments may be implemented by default processes of the operating system of the mobile user device scanning a QR code or NFC code, receiving a URL like those described above, and sending a hypertext transport protocol GET request to the above-describe remote server system with the query string parameters upon that URL being resolved to an IP address of the remote server system. In some embodiments, the remote server system may then respond with instructions that cause the mobile user device to undertake various actions that load program code to the mobile user device to effectuate a new session.

As noted above, various formats may be used to implement client-side logic on the mobile user device. Examples include a previously installed special-purpose native application. Other examples include program code running a web browser, examples including JavaScript and WebAssembly, for instance, in the form of scripts returned by the remote server system (or identified in browser cache on the mobile device) responsive to a GET request like that described in the previous paragraph. In another example, progressive web applications or partial versions of native applications may be returned and used responsive to the GET request. For example, some embodiments may install an instant application in Android operating system devices or an app clip in iOS operating system devices. In some embodiments, these operations may install a relatively lightweight portion of a full native application (or in some cases, there is no full native application) that has elevated privileges relative to a website (e.g., access to a camera and a location service of the OS), has fewer capabilities than a full native application, but installs faster and in some cases requires fewer permissions than a full installation of a native application. In some embodiments, these partial instances of native applications may be previously registered with a provider of the operating system as corresponding to the above-described URL to which the GET request is sent, and some embodiments may verify that the URL is preregistered, for instance, by querying such a registry prior to installing and executing the partial instance of the native application that is returned. In some embodiments, a geolocation of the mobile user device may be queried prior to executing the partial instance of the native application, and that geolocation may be compared to a geolocation of the IDS previously registered with another server system (e.g., to determine whether it is within a geofence specified by a center point and radius), like that of the provider of the operating system that verifies the URL corresponds to the instance of the partial native application. In some embodiments, the mobile device or one of these remote services may determine that the geolocation of the mobile computing device matches one corresponding to the URL, like one corresponding to a query string parameter of the URL. This verification step is expected to impede attacks in which threat actors printout a QR code or apply NFC transmitter to locations in which they do not belong to cause mischief or implement various other attacks. Some embodiments may determine to not run the partial instance of the native application or not display user interface for inputting user input responsive to you the geolocation checker the preregistration of the URL check failing.

In some embodiments, before or after code is sent to the mobile computing device to implement a user interface thereon, some embodiments of the remote server system may establish a session between the mobile user computing device and the IDS. In some embodiments, that remote server system may provide related services to a plurality of IDSs that are geographically distributed, like more than 10, more than 100, more than a 1,000, or more than 10,000 IDSs distributed over an entire state, the country, or the world, in some cases with various tenant accounts corresponding to different tenants having different subsets of those IDSs over which they exercise control.

Establishing a session may take a variety of different forms. In some embodiments, the remote server system may establish a direct connection between the mobile user device and the IDS, such that subsequent exchanges of input user input events are conveyed directly therebetween, for instance passing through networking infrastructure but not being routed through the remote server system to reduce latency. Some embodiments may implement such direct communication via techniques like WebRTC data channels established by the remote server system to effectuate direct communication between the mobile user device and the IDS. Or in some cases, user input events may be routed through the remote server system, and those received input events may be associated with an identifier of a current session, for instance, appended thereto by the client device or a global unique identifier or other identifier of the client device may indicate a current session stored in memory of the remote server system. The remote server system may receive these network indications, identify the session to which they pertain, and based on that session identify the IDS among the population of IDSs served by the remote server system to which the input events pertain. In some embodiments, this lookup operation may include identifying a network address and port number of the particular IDS to which the session pertains. Some embodiments may then send, by operation of the remote server system, the user inputs to the corresponding IDS, like to an IP address of the IDS and a port number of an application or other process executing on the IDS that injects user input events as input to another application running on the IDS that provides the user interface thereon. In some cases, this may include emulating a human interface device (HID), for example, by emulating outputs specified in the USB HID specification or emulating outputs from a driver of an HID.

In some embodiments, the user inputs may take a variety of different forms. In some cases, the user inputs are touch events on a touchscreen on the mobile user device, examples including an on_touch event, a touch_release event, a multitouch event, a drag-and-drop event, or various other gestures. In some embodiments, such events may be associated with coordinates where various parts of the event occurred, like a on_touch or touch_release location. In some cases, those coordinates are in a spatial coordinate system of the mobile user device, like pixel coordinates on of a display screen of the mobile user device, and in some cases those coordinates are also associated with a value that indicates an orientation of the mobile use device, like indicating whether it is in a portrait or landscape mode. In some embodiments, the inputs may also include other attributes, like an amount of force applied at various parts of the input, for instance, with the force touch feature in iOS. Other types of inputs include gaze location for a gaze tracking system on the mobile user device, inertial measurement unit output streams indicating, for example, six axes of acceleration values sensed by an inertial measurement unit (IMU) of the mobile user device, button presses, mouse clicks, scroll events from a scroll wheel, audio of spoken inputs, or video of visual inputs, like gestures performed by the user in view of a camera (which may be a depth sensing camera in some cases) of the mobile user device.

In some embodiments, code may be caused to execute on the mobile user device by the remote server system responsive to the above-described GET request, and that code may register with the operating system to receive these user inputs. In some embodiments, the inputs may then be advanced to the remote server system for relay to the IDS or sent directly to the IDS.

In some embodiments, the inputs may have spatial coordinates as attributes that are in a different coordinate system than that of a screen of the IDS, and some embodiments may translate between these coordinate systems. This translation may be performed by the code executing on the mobile user device, by the code executing at the remote server system, or by the code executing on behalf of the described service on the IDS. In some embodiments, as part of establishing a session, the mobile user device may send a description of its user-input coordinate system, for instance, a number of pixels of screen width and height and an indication of whether the screen is in a landscape or portrait mode (e.g., as part of a user-agent string appended to the above-described GET request). In some embodiments, these values may be updated, for instance, responsive to the user rotating the mobile user device from landscape to portrait mode, and such updates may be sent to other portions of the described system for use in translating between coordinate systems.

In some embodiments, the coordinate translation may take the form of scaling in the horizontal and vertical directions. For example, the mobile user device may have twice as many pixels as the display screen on the IDS in the vertical direction but only one third as many in the horizontal. In some cases, a coefficient for scaling in each of these dimensions may be computed by dividing the difference between the leftmost and rightmost screen locations on the IDS by the leftmost and rightmost locations of the screen on the mobile user device for horizontal dimension scaling factors and by dividing the difference between the topmost and bottommost screen locations on the IDS by the difference between the topmost and bottommost screen locations on the mobile user device. Coordinates of user input events may then be scaled by multiplying by the resulting ratios. Some embodiments may further compute an offset or accommodate different origins of coordinate systems in other ways. In some embodiments, both coordinate systems may be Cartesian coordinate systems, or in some cases, one of the two devices may have a different type of coordinate system. For example, some IDSs may be implemented with a polar or a spherical coordinate system, for instance, with displays implemented on a curved surface for an IDS, like on a sphere. Some embodiments may translate between these coordinate systems by applying various projections, like a stereographic projection function that maps the sphere onto a plane, and translation of coordinates in user input events may be input to these projection functions to translate therebetween.

In some embodiments, multiple types of inputs on the mobile computing device may be combined to effectuate more accurate control on the IDS. For example, an inertial measurement unit of the mobile computing device (or other pose detecting subsystems, like ultra wideband (UWB) sensors sensing output from three spatially arrayed UWB transmitters in range of the IDS) or simultaneous localization and mapping algorithms processing camera input) may produce output from which changes in a pose of the mobile computing device relative to the IMS are detected. These changes in pose may then be used to compute a movement vector used to change an origin of a coordinate system into which inputs on a display screen of the mobile user computing device are mapped to screen location on the IDS. For example, the mobile computing device may then operate like a magnifying glass where moving mobile user computing device left to right or up and down in space coarsely adjusts the region over which control is exerted in the IDS pixel space and fine-grained inputs within that adjustable region are then applied with touch events on a touchscreen of the mobile user computing device. Thus, touching the upper right-hand corner of the display screen of the mobile user device may register as a different location of touch in the pixel space of the IDS after the mobile user device is changed in pose relative to the IDS than before. Similar techniques may be applied to scaling factors, for instance, moving the mobile user computing device closer to the IDS in space may cause a scaling factor to be adjusted to effectuate finer adjustments in location when translating between coordinate systems, and moving the mobile user computing device further from the IDS in space may cause that scaling factor to be adjusted to effectuate coarser, larger adjustments in location, allowing the user to in effect zoom in for finer control by moving their phone or other mobile user computing device in space relative to the IDS.

Some embodiments may inject the translated user input events into an application running on the IDS that presents a user interface of the IDS. For example, the user interface of the IDS may present information about a display in a museum, present user interface by which a user interacts with an ATM machine or gas station pump, presents a user interface by which a user requests information about the location of offices and office building (like a building directory or map), and the like. In some embodiments, and application of the presently describe service executing on the IDS may interface with the remote server system to receive new user input events or may interface directly with the mobile user device upon a session being established to receive new user input events. In some embodiments, this process executing on the IDS may be a distinct application from that of the application that presents the user interface thereon. In some embodiments, the process may be a driver, like a kernel space driver or a user space driver, or combination thereof, executed on the IDS. In some embodiments, the process may establish a network socket connection with a port number associated therewith to which communications are sent by the remote server system or the user computing device, as distinct from other port numbers mapped to other processes by the operating system of the IDS. In some embodiments, user input may be presented to the application that presents the IDS's user interface in a manner that is transparent to that application, such that pre-existing applications can be retrofit without changing their code to accept input from mobile user device rather than a local human interface device like a touchscreen. Thus, in some cases IDS's may be retrofit to allow user input without touching a public IDS without changing existing code thereof, other than to install code of the process by which the inputs are received and injected, for example, as interrupts to be handled by code of the application that presents user interface on the IDS. In some cases, the inputs from the mobile user device may appear to that application as if they are inputs from a local touchscreen.

In some cases, the mobile user device may provide feedback responsive to the user inputs. Examples include displays presenting the region selected on the IDS's display, or some embodiments may provide haptic feedback, e.g., vibrating when the user moves over or selects an UI element on the IDS's user interface.

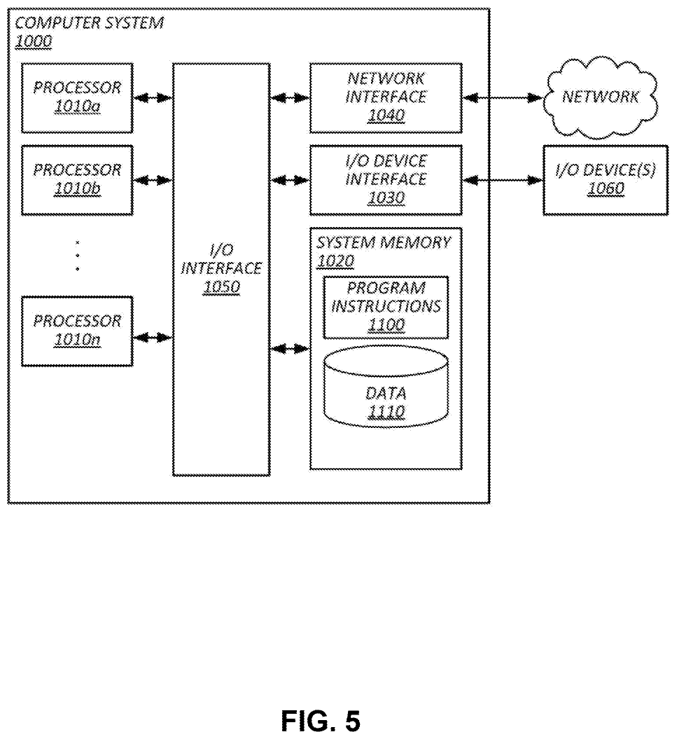

FIG. 5 illustrates an example of a computing system 1000 in which the disclosed embodiments may be implemented. Some embodiments may execute the above operations on a computer system in a host computer system 102, a relay server 122, a dispatcher 205, or a session cache 215 such as the computer system of FIG. 1, which is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. A non-transitory, machine-readable medium storing instructions that when executed by one or more processors effectuate operations comprising:
receiving, with a computer system, a request for connection to a host computer system from a client device, wherein the host computer system hosts an application configured to respond to one or more touch events input by a user at the client device;
generating, with the computer system, a graphical user interface at the client device in response to receiving the request for connection, wherein the graphical user interface is configured to receive the one or more touch events;
establishing, with the computer system, a session between the client device and the host computer system, wherein establishing the session includes:
establishing a first connection between the client device and a first server of a plurality of servers,
establishing a second connection between the first server and the host computer system, and
assigning a session identifier (ID) to the session, wherein the session ID uniquely identifies the session between the host computer system, the first server, and the client device;
receiving, with the first server, the one or more touch events from the client device; and
transmitting, with the first server, the one or more touch events to the host computer system.

2. The medium of claim 1 further comprising:
translating, with the host computer system, the one or more touch events into one or more user input events that causes an interaction with the application at the host computer system.

3. The medium of claim 2, wherein translating the one or more touch events includes:
converting the one or more touch events to the one or more user input events using an application programming interface an operating system of the host computer system.

4. The medium of claim 1, wherein receiving the one or more touch events includes:
receiving the one or more touch events as serialized input event data from the client device.

5. The medium of claim 1, wherein receiving the request for connection includes:
receiving the request from the client device at an Internet Protocol (IP) address corresponding to a uniform resource locator (URL) corresponding to the computer system.

6. The medium of claim 5, wherein receiving the request at the IP address includes:
causing the client device to transmit the request to the IP address in response to the client device scanning a code displayed on the host computer system.

7. The medium of claim 6, wherein the code encodes the URL.

8. The medium of claim 6, wherein the code encodes the session ID.

9. The medium of claim 5, wherein receiving the request at the URL includes:
causing the client device to transmit the request to the URL in response to the client device receiving a beacon from the host computer system.

10. The medium of claim 5, wherein establishing the session includes:
determining, with the computer system, one of the plurality of servers that satisfies a specified condition for facilitating the session between the client device and the host computer system as the first server.

11. The medium of claim 10, wherein the specified condition includes:
at least one of (a) an available computing resource at the one of the plurality of servers is above a first threshold or highest among the plurality of servers, or
(b) a latency associated with transmitting data between the client device and the host computer system via the one of the plurality of servers is below a second threshold or lowest among the plurality of servers.

12. The medium of claim 1, wherein at least one of the first connection or the second connection is established using a full-duplex secure communication protocol.

13. The medium of claim 1 further comprising:
storing the session ID and an identification of the first server in a storage cache associated with the computer system.

14. The medium of claim 13 further comprising:
storing an executable code for rendering the graphical user interface in the storage cache.

15. The medium of claim 1, wherein the graphical user interface is rendered using a web browser application in the client device.

16. The medium of claim 1 further comprising:
receiving a second request for connection to the host computer system from a second client device associated with a second user; and
establishing, with the computer system, a second session between the second client device and the host computer system to receive a set of touch events from the second client device for controlling the application.

17. The medium of claim 16, wherein establishing the second session includes:
terminating the session between the client device and the host computer system prior to establishing the second session.

18. The medium of claim 16, wherein establishing the second session includes:
generating a set of user input events at the host computer system corresponding to the set of touch events received from the second client device via the second session to facilitate interaction with the application for the second user; and
generating one or more user input events at the host computer system corresponding to the one or more touch events received from the client device via the session to facilitate interaction with the application for the user.

19. The medium of claim 1 further comprising:
steps for controlling a host computer system from a mobile computing device.

20. A method comprising:
receiving, with a computer system, a request for connection to a host computer system from a client device, wherein the host computer system hosts an application configured to respond to one or more touch events input by a user at the client device;
generating, with the computer system, a graphical user interface at the client device in response to receiving the request for connection, wherein the graphical user interface is configured to receive the one or more touch events;
establishing, with the computer system, a session between the client device and the host computer system, wherein establishing the session includes:
establishing a first connection between the client device and a first server of a plurality of servers,
establishing a second connection between the first server and the host computer system, and
assigning a session identifier (ID) to the session, wherein the session ID uniquely identifies the session between the host computer system, the first server, and the client device;
receiving, with the first server, the one or more touch events from the client device; and
transmitting, with the first server, the one or more touch events to the host computer system.
